(19) United States
(12) Patent Application Publication
(10) Pub. No.: US 2024/0140014 A1
(43) Pub. Date: May 2, 2024

(54) SCREW EXTRUDER AND METHOD FOR PRODUCING SAME

(71) Applicant: EXTRUDER EXPERTS GMBH & CO. KG, Monschau-Imgenbroich (DE)

(72) Inventors: Matthias STEFFENS, Monschau (DE); Dirk ZIMMERMANN, Monschau (DE)

(21) Appl. No.: 18/387,047

(22) Filed: Nov. 5, 2023

Related U.S. Application Data
(63) Continuation of application No. PCT/EP22/61891, filed on May 2, 2022.

(30) Foreign Application Priority Data
May 10, 2021 (DE) DE102021112163.9

(51) Int. Cl. B29C 48/505

(52) U.S. Cl. CPC B29C 48/507

(57) ABSTRACT

A method for producing an extruder screw, the method including a. sequentially sliding screw segments onto a tensioned longitudinally extending cylindrical tension rod, the screw segments including: i. radially protruding functional elements configured to feed, mix and/or knead an extrudate, ii. a through bore oriented in a longitudinal direction of the extruder screw (1), and iii. an inner spline extending in the through bore in the longitudinal direction of the extruder screw; b. inserting cylindrical coupling pieces including an outer coupling piece spline into the through bore with positive form locking so that the cylindrical coupling pieces connect adjacent screw segments torque proof; and c. axially supporting the screw segments at a tip of the tension rod and clamping the screw segments against the tip of the tension rod, wherein the inner spline extends over an entire length of the through bore.

### RELATED APPLICATIONS

This application is a continuation of International patent application PCT/EP2022/061891 filed on May 4, 2022 claiming priority from German Patent Application DE 10 2021 112 163.9 filed on May 10, 2021, both of which are incorporated in their entirety by this reference.

### FIELD OF THE INVENTION

The invention relates to a method for producing an extruder screw. The invention also relates to an extruder screw.

### BACKGROUND OF THE INVENTION

A spline is a longitudinal teething of a cylindrical surface, wherein the tooth flanks run parallel to a cylinder axis and transfer a torque between a shaft and a hub. Standard splines with involute flanks, wedge flanks and notch flanks can be manufactured in a particularly cost-effective manner.

DE 10 2015 006 479 A1 discloses a generic method and an extruder screw including coupling elements with longitudinal teething slid onto the tension rod between axial faces of two screw segments wherein the coupling elements engage short grooves in axial faces of the screw segments. Extruder screws of this type can be produced more economically and are easier to maintain than a support shaft having longitudinal teething over its entire length as disclosed e.g. in DE 77 01 692 U1.

However, producing the short grooves in the longitudinal direction at an inside of the screw segments is quite complicated and expensive, so that this known extruder screw was not successful in the market place.

DE 10 2016 011 978 A1, DE 37 14 506 A1 and EP 0 688 600 A1 disclose introducing dead holes into axial faces of the screw segments and using plural cylindrical bolts as coupling elements. DE 44 44 370 A1 proposes to bolt adjacent screw segments together through their axial faces. US 2012/0135098 A1 proposes to insert keys into the axial faces. DE 10 2008 028 289 A1 discloses to provide the axial faces with a respective teething.

### BRIEF SUMMARY OF THE INVENTION

Thus it is an object of the invention to simplify fabrication of an extruder screw.

Improving upon the known method it is proposed according to the invention to provide the through bore with a spline over its entire length. The object is achieved by A method for producing an extruder screw, the method comprising: a. sequentially sliding screw segments onto a tensioned longitudinally extending cylindrical tension rod, the screw segments including: i. radially protruding functional elements configured to feed, mix and/or knead an extrudate, ii. a through bore oriented in a longitudinal direction of the extruder screw, and iii. an inner spline extending in the through bore in the longitudinal direction of the extruder screw; b. inserting cylindrical coupling pieces including an outer coupling piece spline into the through bore with positive form locking so that the cylindrical coupling pieces connect adjacent screw segments torque proof; and c. axially supporting the screw segments at a tip of the tension rod and clamping the screw segments against the tip of the tension rod, wherein the inner spline extends over an entire length of the through bore.

The extruder screw according to the invention can be produced with screw segments which are commercially available in a great variety for an application in screw extruders with one piece support shafts with a longitudinal spline. Thus, the invention significantly simplifies fabrication of the extruder screw.

According to the invention the screw segments are clamped against the tension rod, the coupling elements have sufficient clearance in the longitudinal direction so that a double fit with undefined tension in the screw segments after clamping the tension rod is avoided. When using standard length coupling elements the clearance can be adjusted by simple tube segments without teething between the coupling pieces.

Advantageously a drive segment with an outer spline is slid on in a last step according to the method according to the invention. Drive segments with a spline matching a drive hub are known in the art. The drive segment can engage a terminal screw segment like a coupling element with an outer spline by form locking. Alternatively the drive segment can engage a terminal coupling element like a screw segment with an inner spline. This drive segment can be configured as a terminal screw segment with corresponding functional elements configured for feeding, mixing and/or kneading.

Advantageously a clamping nut is threaded onto the tension rod as a last step at a rear end of the tension rod that is opposite to the tip according to the method according to the invention. The tension rod includes an external thread at a rear end according to the method according to the invention. The clamping nut then clamps the screw segments indirectly between the tip and the clamping nut. The clamping nut is not mechanically or thermally loaded during operation of the extruder screw. The clamping nut is not in contact with the extrudate, no accretions are formed thereon and the clamping nut does not wear mechanically and is not heated up. Thus the clamping nut can be removed easily after tension has been relieved from the tension rod when the extruder screw is being maintained.

Advantageously the clamping nut includes the spline of the drive segment according to the method according to the invention. The clamping nut is then mechanically secured by the corresponding inner teething of the drive during operation of the extruder screw.

Further advantageously the clamping nut is aligned at the spline of the drive segment by an alignment sleeve according to the method according to the invention. The alignment sleeve prevents unintentional rotation of the clamping nut before an elongation of the tension rod is relieved and the clamping nut clamps the screw segments against the tip indirectly.

Advantageously the tension rod is initially tensioned in order to clamp the screw segments and subsequently fixed in the tensioned condition. An unintentional torsion loading of the tension rod is thus avoided.

Advantageously the tension rod is tensioned hydraulically according to a method according to the invention. Hydraulic press cylinders are economically available in a great variety.

Further advantageously the tension rod is fixed in the tensioned condition by the clamping nut according to the method according to the invention. Fixing by the clamping nut is well known in the art.

Further advantageously a clamping device is supported at the screw segments according to the method according to the invention in order to tension the tension rod. When supporting the clamping device at the screw segments an additional support structure is not necessary. In particular the clamping device can be supported at the screw segments indirectly through a drive segment.

Improving upon the known extruder screw it is proposed according to the invention that the pass-through bore is provided with the spline over an entire length of the pass-through bore. The extruder screw according to the invention is produced according to a method according to the invention and is characterized by the same advantages as the method.

Further advantageously a tip of the extruder screw according to the invention includes an inner spline corresponding to the spline of the coupling elements. The extruder screw according to the invention effectively prevents an unintentional rotation of the tip relative to the screw elements.

Extruder screws according to the invention are used in single screw extruders, twin, or multi-screw extruders co-rotating or counter-rotating

### BRIEF DESCRIPTION OF THE DRAWINGS

The invention is subsequently described based on embodiments with reference to drawing figures wherein:

FIGS. 1A-1F illustrate fabrication steps for an extruder screw according to the invention;

FIGS. 2A-2C illustrate a screw segment according to the invention of the extruder screw according to the invention;

FIGS. 3A-3B illustrates a detail of the extruder screw according to the invention;

FIG. 4 illustrates a longitudinal sectional view of the extruder screw according to the invention;

FIGS. 5A and 5B illustrate the extruder screw including the clamping device;

FIG. 6A, 6B illustrate a detail of the clamping device;

FIGS. 7A and 7B illustrate steps for producing another embodiment of the extruder screw according to the invention;

### DETAILED DESCRIPTION OF THE INVENTION

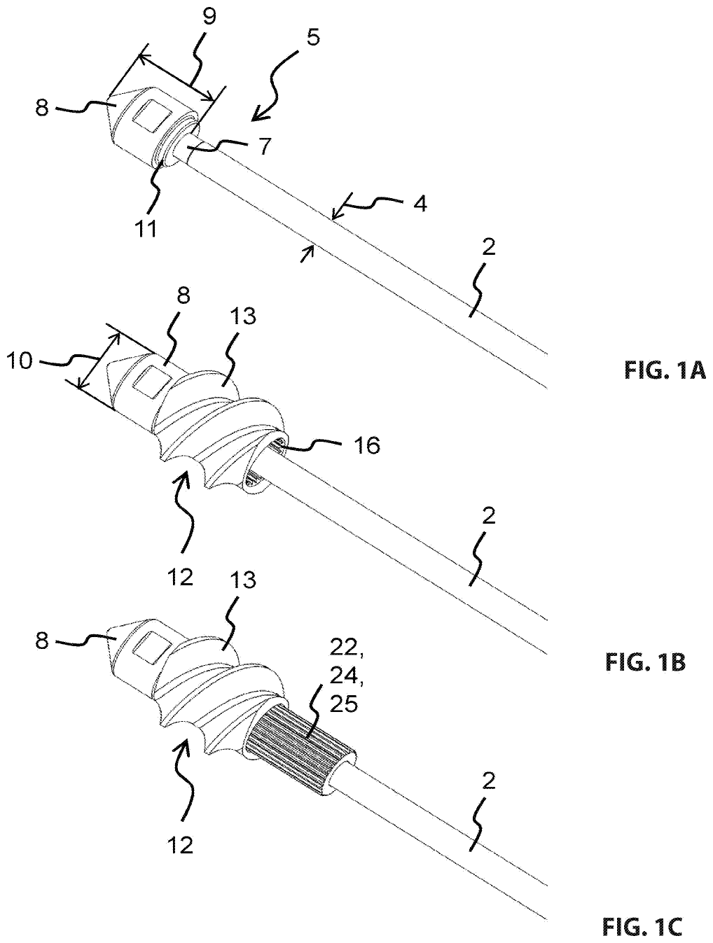

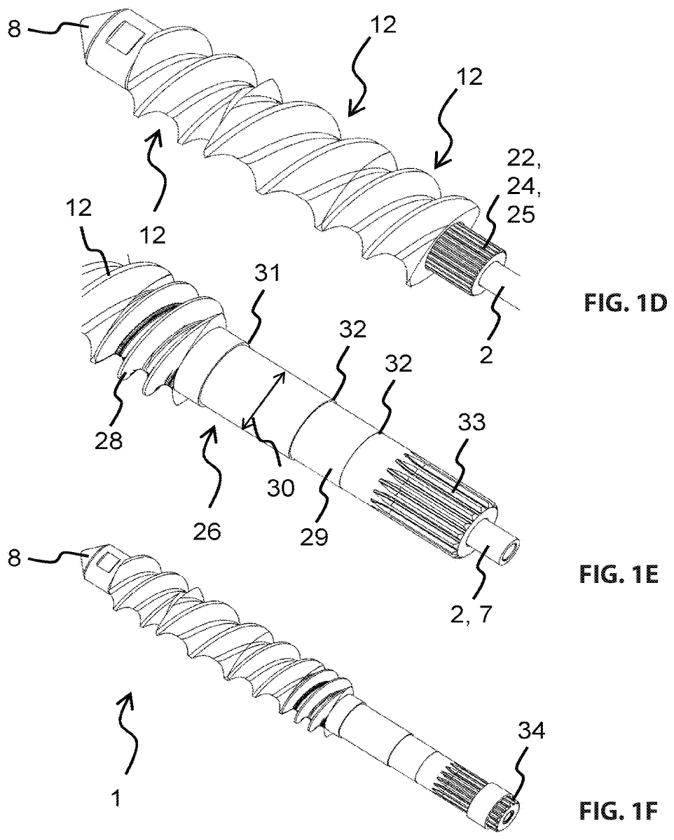

The extruder screw 1 according to the invention illustrated in its entirety in FIG. 1F includes a tension rod 2. The tension rod 2 is made from mild steel and has a length 3 of 440 mm, a diameter 4 of 16.5 mm at a front end 5 and a fine thread 7 (M16×0.5) with a length of 25 mm and a rear end 6. As illustrated in FIG. 1A a tip 8 is initially threaded onto the front end 5. The tip 8 has a length 9 of 44.5 mm, a diameter 10 of 39 mm and an axially protruding centering boss 11.

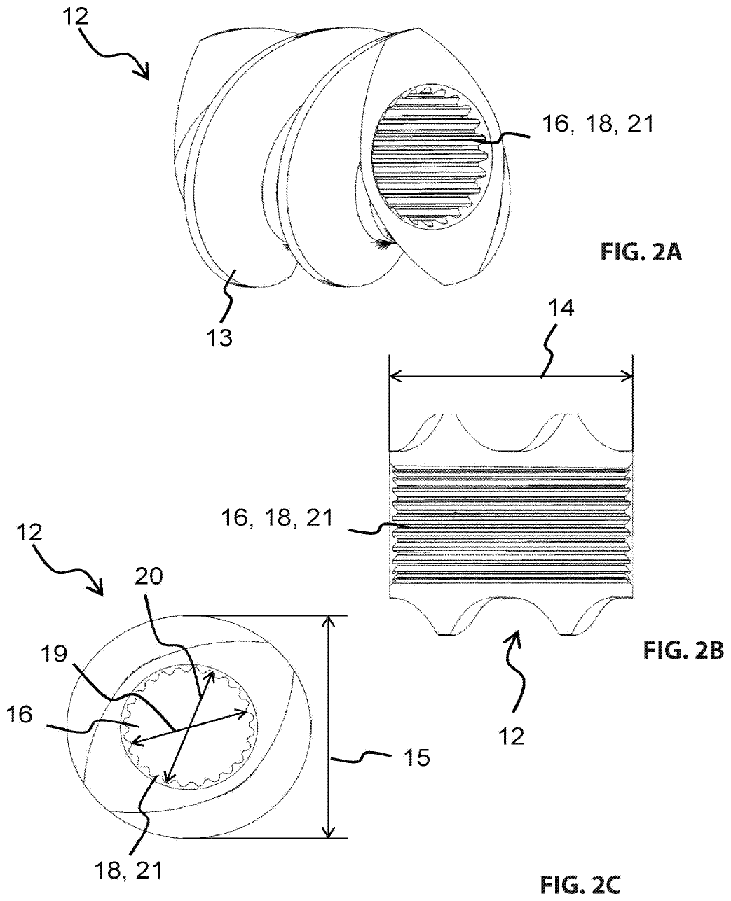

A first screw segment 12 with functional elements 13, thus with a screw helix configured to feed extrudate by the extruder screw 1 in a screw extruder is applied to the centering boss 11 as illustrated in FIG. 1B. The screw segment 12 illustrated in detail in FIGS. 2A through 2C has a length 13 and a diameter 14 of 60 mm respectively and a pass-through bore 16 that has a spline 18 according to the DIN 5480 over its entire length. The spline 18 has an inner tip diameter 19 of 29.5 mm an outer tip diameter 20 of 32 mm and 24 teeth 21 with notch flanks.

A tubular coupling piece 22 is inserted between the screw segment 12 and the tension rod 2 as shown in FIG. 1C. The coupling piece 22 is made from mild steel and has a standard length 23 of 60 mm, an inner diameter of 16.5 mm and a spline 25 that corresponds to the screw segment 12 on an outer cylindrical surface 24 of the coupling piece 22.

Two additional screw segments 12, a respective coupling piece 22 and last not least a drive segment 26 is slid onto the tension rod 22 as illustrated in FIG. 1E in the same manner as illustrated in FIG. 1D. Tubular pieces without teething are inserted between the coupling pieces 22 in order to adjust the clearance of the coupling pieces in the longitudinal direction of the extruder screw 1.

The drive segment 26 includes functional elements thus screw helixes over a length 27 of 209 mm adjacent to the screw segments 12 and an inner spline corresponding to the coupling pieces 22 and adjacent thereto a tube 29 with an inner diameter of 16.5 mm and an outer diameter 30 that is reduced from 39.6 mm in three steps 31, 32 to 34.3 mm and which terminates in an outer spline 33.

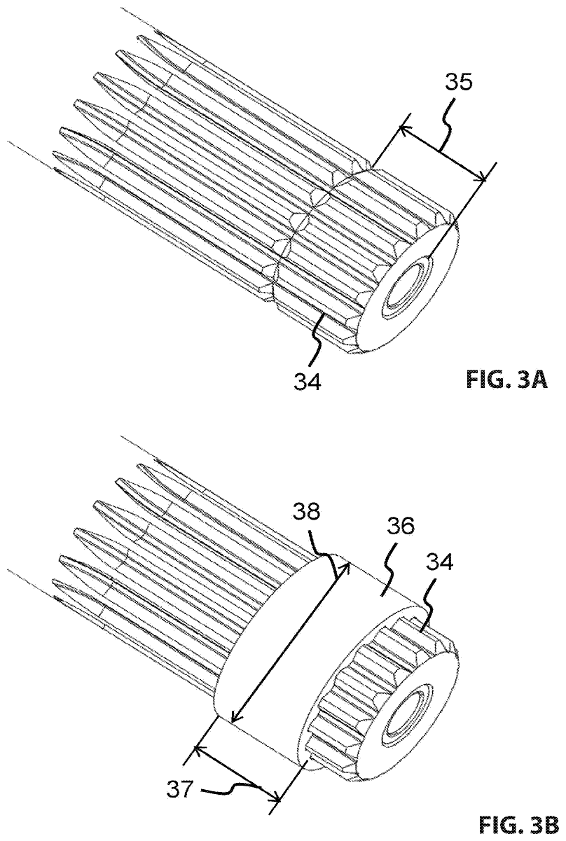

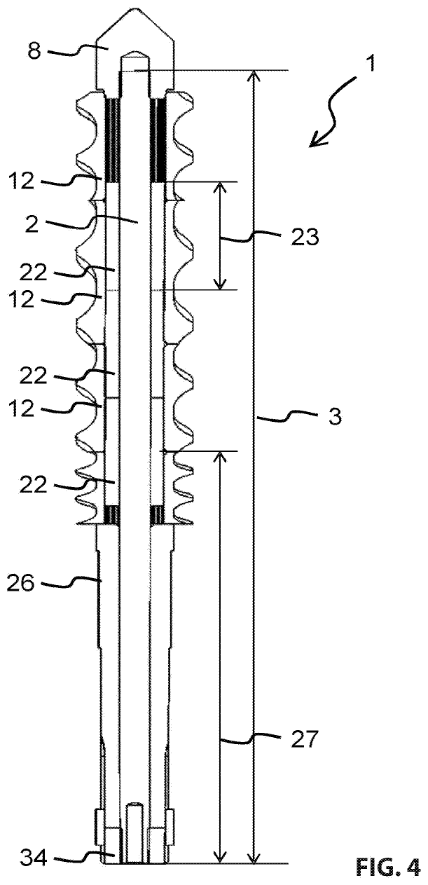

A clamping nut 34 with a length 35 of 20 mm is threaded onto the fine thread 7 at a rear end 6 of the tension rod 2 as illustrated in FIG. 1F and illustrated in detail in FIGS. 3A and 3B, wherein the clamping nut includes the outer spline 33 of the drive segment 26. An alignment sleeve 36 with a length 37 of 20 mm and an outer diameter 38 of 39.5 mm is slid over the clamping nut 34 and the drive element 26 completing pre-assembly. The alignment sleeve 36 has an inner teething that corresponds to the spline 18 and thus prevents a rotation of the clamping nut 34 relative to the alignment sleeve 36.

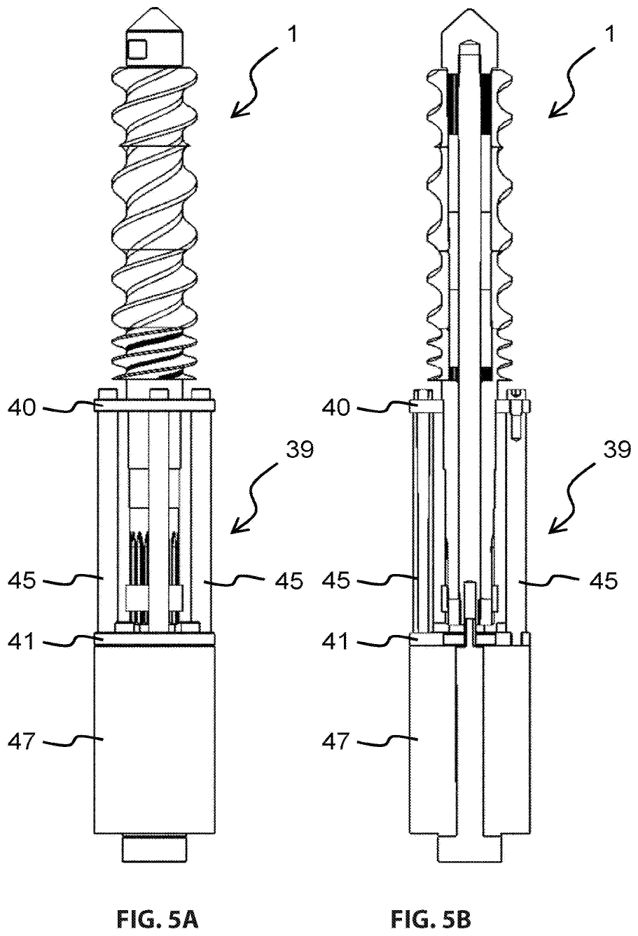

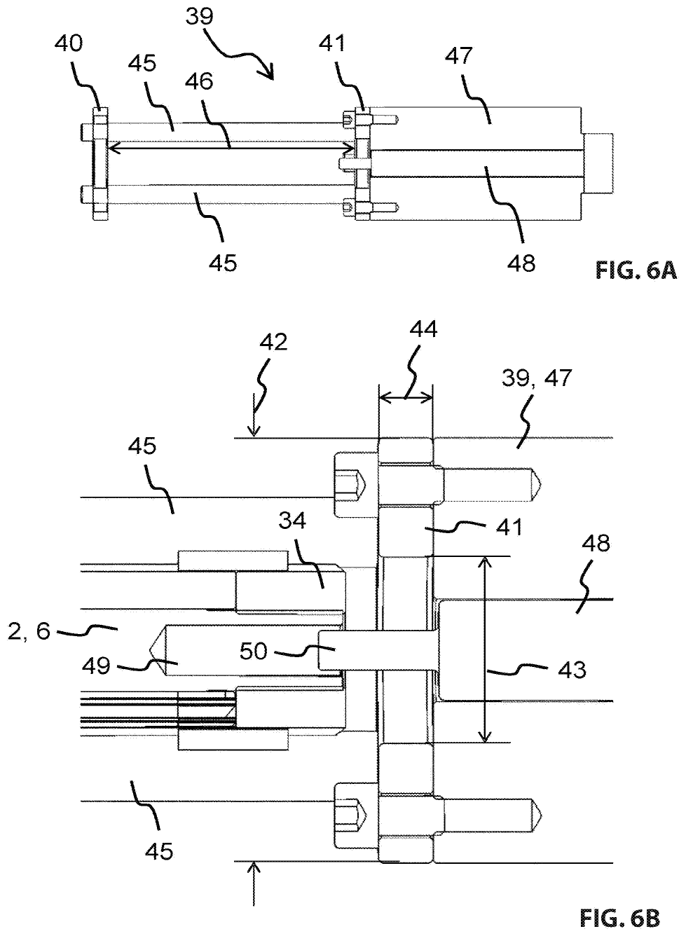

A clamping device 39 is mounted at the preassembled extruder screw 1 as illustrated in FIGS. 5A, B in order to clamp the tension rod 2. The clamping device 39 is illustrated in detail in FIGS. 6A, B.

The clamping device 39 includes two circular support rings 40, 41 having an outer diameter 42 of 85 mm, an inner diameter 43 of the 38 mm and a thickness 44 of 10 mm that are supported by four support rods 45 at a distance 46 of 170 mm. The front support ring 40 is supported at the first shoulder of the drive segment 26 and thus indirectly supported at the screw segments 12. A hydraulic hollow piston cylinder 47 is attached at the rear support ring 41.

A rear end 6 of the tension rod 2 includes a bore hole 49 with an inner thread M10 in order to connect a piston 48 of the hollow piston cylinder with the tension rod 2, wherein a pin 50 of the piston 48 is threaded into the inner thread M10. Then, the tension rod 2 is pulled out of the extruder screw 1 by the piston 48 with a force of 40 kN

The alignment sleeve 36 is pushed in the tensioned position onto the drive segment 26 far enough so that the alignment sleeve releases the clamping nut 34. The clamping nut 34 is then clamped hand tight and secured again by the alignment sleeve 36. Now the piston 48 can be unloaded and the clamping device 39 dismounted.

During maintenance of the extruder screw 1 after a predetermined operating period, the tension of the tension rod can be readjusted in the same way, when damaged or worn during operation the extruder screw 1 can be dismounted easily in order to replace individual screw segments.

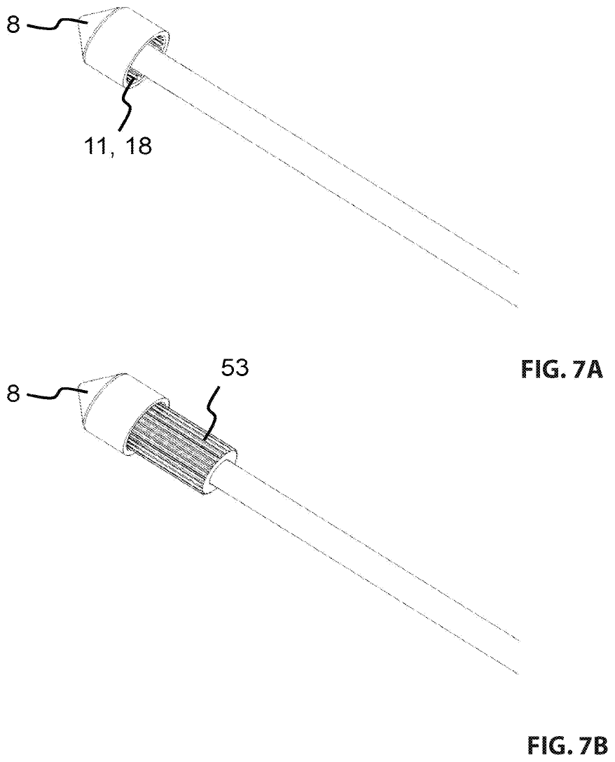

An additional extruder screw according to the invention corresponds to the first extruder screw 1, wherein the tip 51 includes a dead hole 52 with the spline 18 instead of the centering boss 11, wherein a coupling piece 53 is initially inserted into the dead hole 52 which differs from the FIGS. 7A and 7B.

### REFERENCE NUMERALS AND DESIGNATIONS

1 extruder screw
2 tension rod
3 length
4 diameter
5 front end
6 rear end
7 fine thread
8 tip
9 length
10 diameter
11 centering boss
12 screw segment
13 functional element
14 length
15 diameter
16 pass-through bore
18 spline
19 inner tip diameter
20 outer tip diameter
21 tooth
22 coupling piece
23 length
24 cylindrical surface
25 spline
26 drive segment
27 length
28 functional element
29 tube
30 outer diameter
31 shoulder
32 shoulder
33 spline
34 clamping nut
35 length
36 alignment sleeve
37 length
38 outer diameter
39 clamping device
40 support ring
41 support ring
42 outer diameter
43 inner diameter
44 thickness
45 support rod
46 distance
47 hollow piston cylinder
48 piston
49 bore hole
50 pin
51 tip
52 dead hole
53 coupling piece

What is claimed is:

1. A method for producing an extruder screw, the method comprising:
a. sequentially sliding screw segments onto a tensioned longitudinally extending cylindrical tension rod, the screw segments including:
i. radially protruding functional elements configured to feed, mix and/or knead an extrudate,
ii. a through bore oriented in a longitudinal direction of the extruder screw, and
iii. an inner spline extending in the through bore in the longitudinal direction of the extruder screw;
b. inserting cylindrical coupling pieces including an outer coupling piece spline into the through bore with positive form locking so that the cylindrical coupling pieces connect adjacent screw segments torque proof; and
c. axially supporting the screw segments at a tip of the tension rod and clamping the screw segments against the tip of the tension rod,
wherein the inner spline extends over an entire length of the through bore.

2. The method according to claim 1, further comprising: sliding a drive segment including an outer drive segment spline onto the tension rod.

3. The method according to claim 2, further comprising: threading a clamping nut onto the tension rod as a last step.

4. The method according to claim 3, wherein an outer clamping nut spline of the clamping nut corresponds to the outer drive segment spline of the drive segment.

5. The method according to claim 4, wherein the clamping nut is aligned at the outer drive segment spline by an alignment sleeve.

6. The method according to claim 3, further comprising:
hydraulically tensioning the tension rod; and
subsequently fixing the tension rod by the clamping nut in a tensioned condition of the tension rod so that the screw segments are clamped.

7. The method according to claim 6, further comprising: supporting a clamping device in the longitudinal direction at the screw segments so that the tension rod is tensioned.

8. An extruder screw, comprising:
a.) a longitudinally extending cylindrical tension rod;
b.) screw segments including:
i.) radially protruding functional elements configured to feed, mix and/or knead an extrudate,
ii.) a through bore oriented in the longitudinal direction of the extruder screw (1), and
iii.) an inner spline extending in the through bore in the longitudinal direction of the extruder screw,
wherein the screw segments are axially supported at a tip of the tension rod and clamped against the tip of the tension rod;
c.) cylindrical coupling pieces including an outer coupling piece spline inserted into the through bore with positive form locking so that the cylindrical coupling pieces connect adjacent screw segments torque proof,
wherein the inner spline extends over an entire length of the through bore.

9. The extruder screw according to the preceding claim, wherein the tip includes the inner spline.

10. A screw extruder, comprising: at least one extruder screw according to claim 9.
